(19) United States
(12) Patent Application Publication
(10) Pub. No.: US 2009/0055914 A1
(43) Pub. Date: Feb. 26, 2009

(54) SOFTWARE UPDATE METHOD

(75) Inventor: Osamu AZAMI, Shiojiri-shi (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 12/196,706

(22) Filed: Aug. 22, 2008

(30) Foreign Application Priority Data
Aug. 23, 2007 (JP) 2007-216868

(51) Int. Cl. H04L 9/32; G06F 21/00

(52) U.S. Cl. 726/7

(57) ABSTRACT

A method of updating first software in at least one apparatus in which a first password is set and which determines, when receiving a second password and second software, whether or not the received second password matches the first password set in the apparatus and whether or not the received second software is for the apparatus, when the second password matches the first password and the second software is for the apparatus. The method includes; causing a user to select the apparatus from among a plurality of apparatuses; causing the user to input the second password; causing the user to designate an update file pertaining to the second software; storing information of the apparatus selected by the user, the second password input by the user and the update file designated by the user; and performing update processing to transmit the second password and the second software in the update file to the apparatus selected by the user in accordance with the stored information.

### BACKGROUND

1. Technical Field

The present invention relates to a software update method for updating software of a software-updatable apparatus, such as a printer.

2. Related Art

A related-art printer is implemented as an apparatus capable of updating firmware and set data (updating/changing specifics) by operation of a PC connected thereto; however, the related-art printer is also embodied as an apparatus that requires entry of a password at the time of updating of firmware and set data.

For this reason, a printer administrator of a location where a large number of printers are used, such as an office and a university, must perform laborious work, such as repetition of update operation including inputting of a password, in equal number to the printers when firmware of all of the printers is updated or when settings of all of the printers are changed.

An advantage of some aspects of the invention is to provide a software update method that enables a much-easier update of software of a plurality of software-updatable apparatuses, such as printers.

According to an aspect of the invention, there is provided a method of updating first software in at least one apparatus in which a first password is set and which determines, when receiving a second password and second software, whether or not the received second password matches the first password set in the apparatus and whether or not the received second software is for the apparatus, when the second password matches the first password and the second software is for the apparatus, the method comprising:

causing a user to select the apparatus from among a plurality of apparatuses;

causing the user to input the second password;

causing the user to designate an update file pertaining to the second software;

storing information of the apparatus selected by the user, the second password input by the user and the update file designated by the user; and

performing update processing to transmit the second password and the second software in the update file to the apparatus selected by the user in accordance with the stored information.

The present disclosure relates to the subject matter contained in Japanese patent application No. 2007-216868 filed on Aug. 23, 2007, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a descriptive view of the use mode of a software update program of an embodiment.

FIG. 2 is a descriptive view of an update target apparatus selection screen indicated on a display by the software update program.

FIG. 3 is a descriptive view of firmware update processing executed by the software update program.

FIG. 4 is a descriptive view of a processing status-and-result report screen indicated on the display by the software update program.

FIG. 5 is a descriptive view of an inquiry screen indicated on the display by the software update program.

FIG. 6 is a descriptive view of a progress status screen indicated on the display by the software update program.

FIG. 7 is a descriptive view of the processing status-and-result report screen indicated on the display by the software update program.

### DESCRIPTION OF EXEMPLARY EMBODIMENTS

The best mode for practicing the present invention will be described hereunder in detail by reference to the drawings.

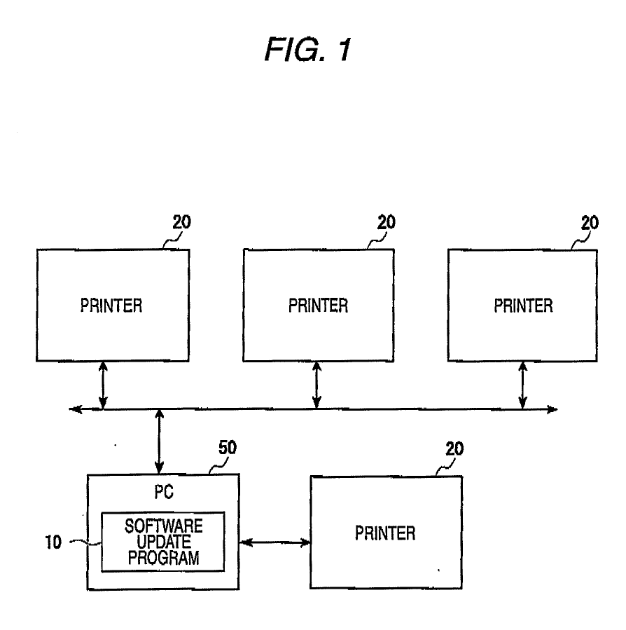

First, the general outline (applications and a use environment) of a software update program 10 of an embodiment of the present invention will be described by reference to FIG. 1.

As schematically shown in FIG. 1, the software update program 10 of the embodiment of the present invention is a program that runs on a PC (personal computer) 50 connected to (connected by way of a network/connected directly) to a plurality of printers 20.

The software update program 10 of the present embodiment is a program developed for facilitating an update of various firmware (programs) and set data (set values for various items that can be set by means of operations performed by way of an operation panel, and the like) in the plurality of printers 20.

The printers 20 capable of updating software (firmware or set data) thereof by means of the software update program 10 are various types of apparatuses that differ from each other in terms of a specific configuration and function.

Each of the printers 20 is embodied as an apparatus as follows. Namely, when receiving update request information of a predetermined format including a password and software (firmware or set data) to be updated, the apparatus determines that conditions; namely, “whether or not the password in the information matches a password set in the apparatus and whether or not the software in the information is for the apparatus” are fulfilled. When the conditions are fulfilled, the apparatus actually updates the software in the apparatus and returns processing result information to the effect of normal completion of an update (or processing result information to the effect of a failure in update) to an apparatus that is the sender of the update request. When the conditions are not fulfilled, the apparatus returns, without updating the software, processing result information indicating that the password is incorrect or processing result information indicating that the software is not intended for the apparatus to the apparatus which is the sender of the update request. Further, each of the printers 20 is also embodied as an apparatus having a function of returning information including its IP address, MAC address, and the like, to an apparatus that has transmitted a broadcast request of predetermined specifics (a request of predetermined specifics having, as an address, a broadcast address) and a function of transmitting information administered by itself (version information about respective pieces of software, the date and time when set data have been set (updated)) to the apparatus that has issued the request.

Moreover, each of the printers 20 also doubles as an apparatus that can make various settings by means of operation of a PC (a Web browser) connected thereto and that can save a file pertaining to various setting values (a file whose duplicate can be created by a text editor) in a PC.

Functions of the software update program 10 of the embodiment will now be described.

The software update program 10 is embodied as a program that, when launched (executed), displays on a display of a PC 50 a select screen about a firmware update file or a set data updated file. The firmware update file is a file of firmware to be update (a file that can be downloaded from a predetermined WEB site), and a set data update file is a file (or a file created by a text editor) created by making an access to a certain printer 20 by means of a Web browser.

When a certain firmware update file (denoted as a “designated update file”) is selected, the software update program 10 grasps all of the printer 20 connected to the PC by way of a network or directly, and performs processing for grasping version information about firmware to be updated by the designated update file in each of the printers 20. Specifically, the software update program 10 performs, by means of transmission of a broadcast request, processing for acquiring version information from the printer 20 whose presence has been grasped and processing for searching a port to which the printer 20 is connected and acquiring version information from the printer 20 connected to the port.

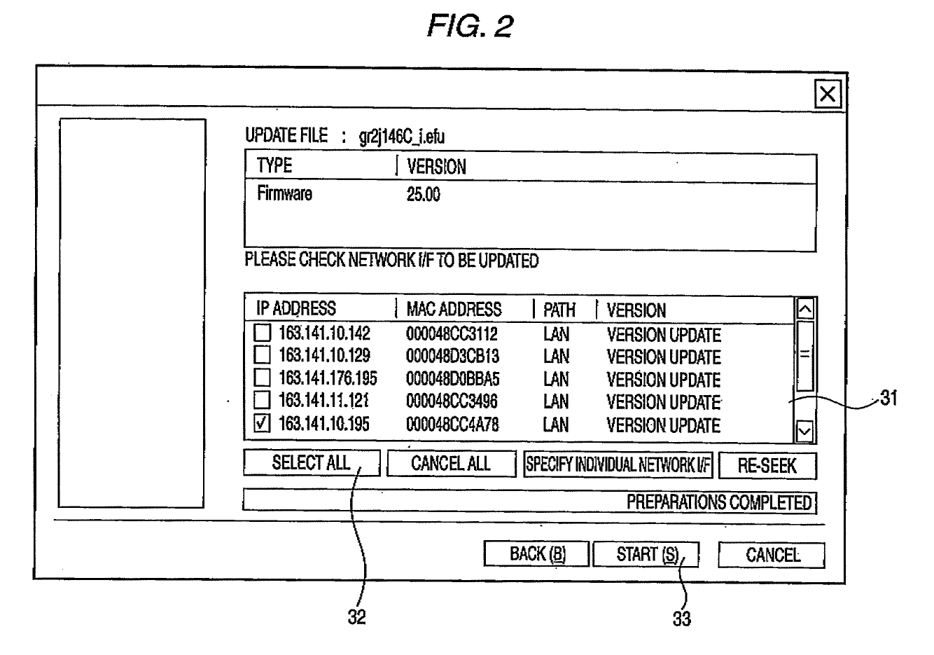

Subsequently, the software update program 10 indicates an update target apparatus selection screen of a configuration shown in FIG. 2 on a display of the PC 50 by utilization of the thus grasped information. A printer selection field 31 on the update target apparatus selection screen is a field where an operable checkbox, an IP address and a MAC address (whose values are displayed only when a path is a “LAN”), a path (a LAN, a USB, and the like), and information about whether or not an update of firmware effected by a designated update file is a version upgrade (“version upgrade” is drawn in the drawing) are provided for each of the printers 20 connected to the PC 50. An “all select” button 32 on the update target apparatus selection screen is a button to be operated by an operator when all checkboxes in the printer selection field 31 are desired to be checked. A “start” button 33 is a button to be operated by the operator when the software update program 10 is caused to initiate processing for updating firmware of several printers 20 for which checkboxes have been checked.

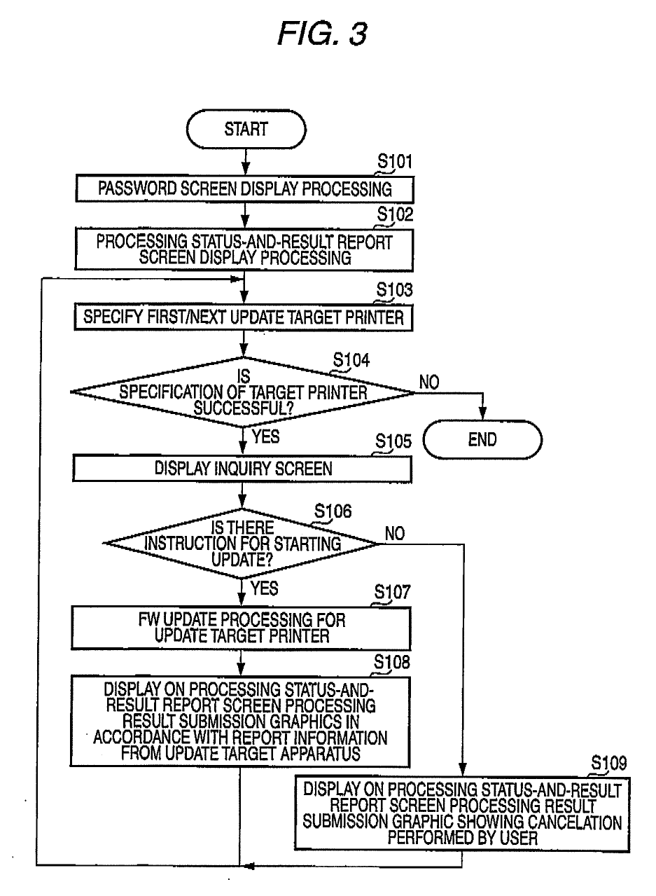

The software update program 10 of the embodiment is designed as a program that executes processing pertaining to procedures shown in FIG. 3 as firmware update processing to be commenced at the time of operation of the “start” button 33.

Specifically, since the “start” button 33 is operated, the software update program 10 commenced firmware update processing first indicates a screen that enables entry of a password on the display, thereby performing password screen display processing (step S101) that is processing for the operator to input a password set commonly to all (or the great majority) of the printers 20.

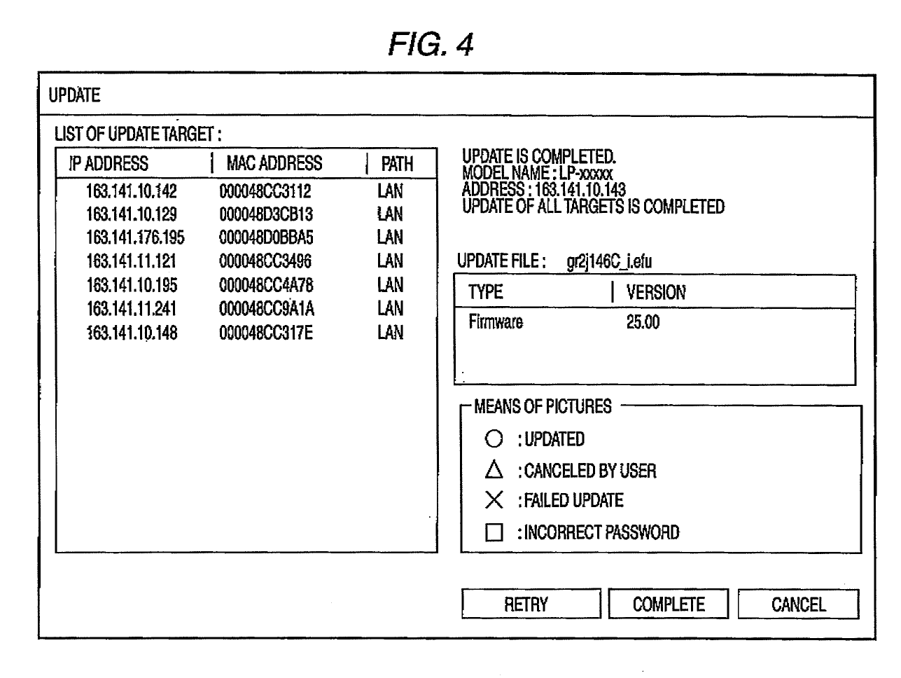

Subsequently, the software update program 10 performs processing status-and-result report screen display processing (step S102) for indicating a processing status-and-result report screen of a configuration shown in FIG. 4 on the display, and performs processing (step S103) for specifying, as an update target printer 20, one printer 20 (having not yet undergone processing) among the printers 20 (the printers 20 for which checkboxes on the update target apparatus selection screen are checked) selected as targets of firmware update processing.

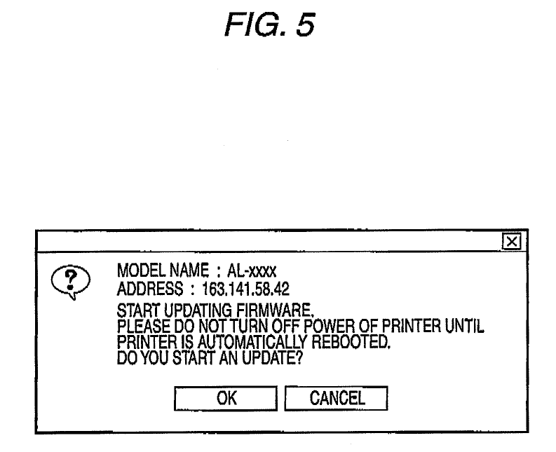

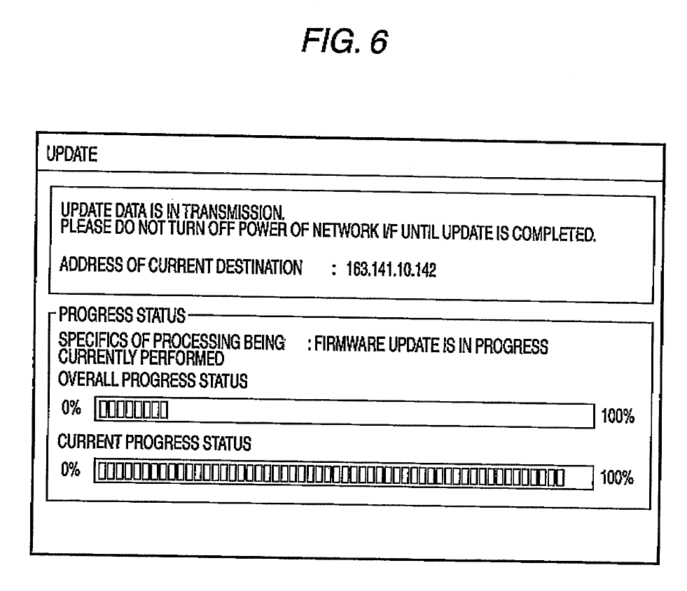

When the update target printer 20 can be specified (YES in step S103), the software update program 10 indicates an inquiry screen of a configuration shown in FIG. 5 on the display (step S105). When an OK button on the inquiry screen is operated (YES in step S106), the software update program 10 transmits the previously-described update request information to the update target printer 20 in step S107 and subsequently performs processing for waiting information about the previously-described processing result to be transmitted from the update target printer 20 (FW update processing for the update target printer in the drawing). When performed first time, processing pertaining to step S107 serves as processing during which processing for displaying a progress status screen of a configuration shown in FIG. 6 and processing for updating specifics of the progress status screen (processing for updating specifics of a display of a progress bar in accordance with a progress status) are performed. When performed the second time or a subsequent time, processing serves as processing for updating specifics of the previously-displayed progress status screen (FIG. 6).

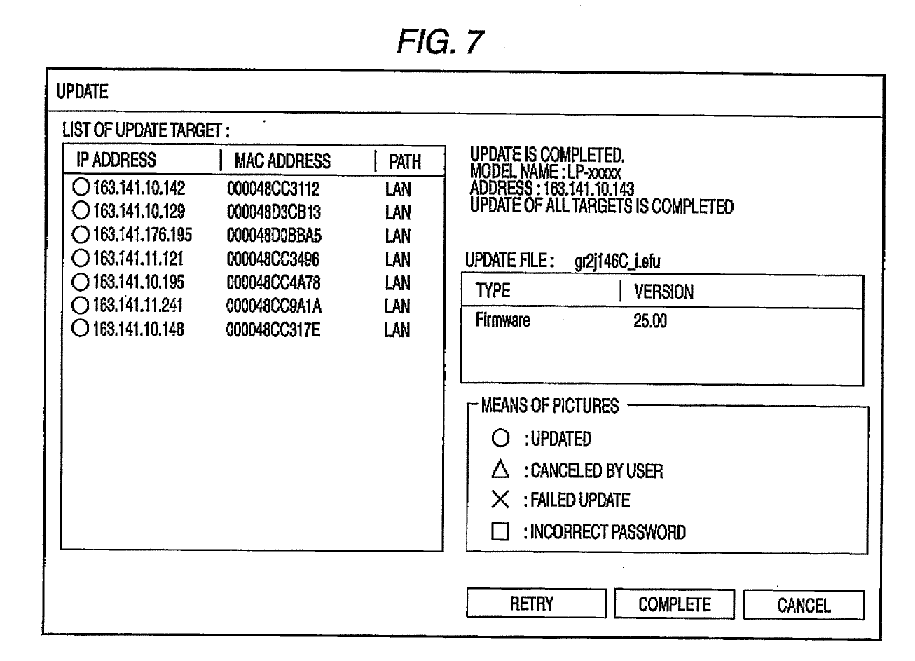

When processing pertaining to step S107 is completed (when the processing result information is transmitted from the update target printer 20), the software update program 10 performs processing (step S108) for displaying a processing result submission graphics representing information about a result of processing on the left side of the information about the update target printer 20 appearing on the processing status-and-result report screen (an IP address or the like) as shown in FIG. 7. The processing result submission graphics are four pictures displayed along with their meanings at lower right positions of FIG. 7 (and FIG. 4) (a picture showing completion of an update (a successful update), a picture showing cancellation of an update by the user, a picture showing an update failure, and a picture showing an incorrect password). The processing status-and-result report screen shown in FIG. 7 is for the case where all of the steps of firmware update processing shown in FIG. 3 are completed.

When a cancel button on the inquiry screen of the configuration shown in FIG. 5 is operated (NO in step S106), the software update program 10 performs processing for displaying a processing result submission graphics showing that the update is cancelled by the user on the left side of information about the update target printer 20 appearing on the processing status-and-result report screen (step S109).

The software update program 10 having completed processing pertaining to step S109 or S109 returns to step S103, where processing for the next printer 20 is commenced. When processing for all of the printers 20 selected as update targets are completed (NO in step S104), firmware update processing is completed.

Processing performed by the software update program 10 when a certain set data update file is also analogous to that mentioned above. Processing performed by the software update program 10 when the set data update file is selected corresponds to processing for displaying, as an update target apparatus selection screen (see FIG. 2) a screen on which a set date and time (the recent date and time when setting of any of item value is changed) of set data is displayed on an area of an area on the update target apparatus selection screen of in FIG. 2 where an update is indicated.

As is obvious from the above descriptions, the software update program 10 of the present embodiment is embodied as a program capable of globally updating firmware of all of the printers 20, so long as a single password is set for all of the printers 20 in the office or the like (a program for obviating a necessity of operation for updating firmware for each printer 20). The software update program 10 is also embodied as a program that enables alteration of setting of the plurality of printers 20 by means of the set data update file. Therefore, management of the plurality of printers 20 used in the office or the like (updating of firmware or making settings identical with each other) can be performed extremely simply, so long as the software update program 10 is used.

<Modified Mode>

The foregoing software update program 10 enables various modifications. For instance, the software update program 10 can be modified as a program that does not display the inquiry screen shown in FIG. 5 (a program that does not execute processing pertaining to steps S106 and S107). As a matter of course, the software update program 10 may also be modified into a program for enabling an update of only firmware, a program for displaying, as various screens, screens that differ in specific configuration from those mentioned above, a program for updating software of an apparatus other than the printer 20, or the like.

What is claimed is:

1. A method of updating first software in at least one apparatus in which a first password is set and which determines, when receiving a second password and second software, whether or not the received second password matches the first password set in the apparatus and whether or not the received second software is for the apparatus, when the second password matches the first password and the second software is for the apparatus, the method comprising:
causing a user to select the apparatus from among a plurality of apparatuses;
causing the user to input the second password;
causing the user to designate an update file pertaining to the second software;
storing information of the apparatus selected by the user, the second password input by the user and the update file designated by the user; and
performing update processing to transmit the second password and the second software in the update file to the apparatus selected by the user in accordance with the stored information.

2. The method according to claim 1 further comprising:
outputting information whether or not the update processing is successful.

3. The method according to claim 1 further comprising:
before performing the update processing, inquiring of the user about whether or not to perform the update processing.

4. A computer program product for enabling a computer connected to the plurality of apparatuses to execute the method according to claim 1.

5. A computer-readable recording medium in which a computer program causing a computer connected to the plurality of apparatuses to execute the method according to claim 1 is recorded.
